(19) United States
(12) Patent Application Publication
(10) Pub. No.: US 2011/0033748 A1
(43) Pub. Date: Feb. 10, 2011

(54) HYDROGEN-ABSORBING ALLOY POWDER, METHOD FOR TREATING THE SURFACE THEREOF, NEGATIVE ELECTRODE FOR ALKALINE STORAGE BATTERY, AND ALKALINE STORAGE BATTERY

(76) Inventors: Kyoko Nakatsuji, Kanagawa (JP); Hideaki Ohyama, Kanagawa (JP)

Correspondence Address: MCDERMOTT WILL & EMERY LLP, 600 13TH STREET, NW, WASHINGTON, DC, 20005-3096, US

(21) Appl. No.: 12/673,903

(22) PCT Filed: Apr. 30, 2009
(86) PCT No.: PCT/JP2009/001971

§ 371 Date: Feb. 17, 2010

(30) Foreign Application Priority Data
May 30, 2008 (JP) 2008-143542

(51) Int. Cl. H01M 4/58; B01J 20/02; H01F 1/04

(52) U.S. Cl. 429/218.2; 502/406; 252/62.55

(57) ABSTRACT

Provided is a hydrogen occluding alloy powder having an ideally activated surface state where oxide and hydroxide precipitated on the surface of said powder have been removed quickly with a simple means. The method for surface treating a hydrogen occluding alloy powder involves agitating a hydrogen occluding alloy powder containing Ni and Mg with an Ni content from 35 to 60 wt % in a lithium hydroxide aqueous solution (first process). Then the hydrogen occluding alloy powder is agitated in an alkali metal hydroxide aqueous solution containing at least either one of sodium hydroxide and potassium hydroxide (second process).

### TECHNICAL FIELD

The invention relates to a method for treating the surface of a hydrogen-absorbing alloy powder capable of electrochemically absorbing and desorbing hydrogen, and more particularly, to an improvement in the surface treatment conditions for a hydrogen-absorbing alloy powder. The invention further pertains to a negative electrode for an alkaline storage battery including a hydrogen-absorbing alloy powder, and to an alkaline storage battery including the same.

### BACKGROUND ART

A hydrogen-absorbing alloy powder is an intermetallic compound capable of electrochemically absorbing and desorbing hydrogen, and is mainly used as a negative electrode material for alkaline storage batteries. A hydrogen-absorbing alloy powder repeatedly expands and contracts in an alkaline electrolyte in charge/discharge after battery fabrication. The repeated expansion and contraction activate the hydrogen-absorbing alloy powder, thereby facilitating the absorption and desorption of hydrogen on the surface of the hydrogen-absorbing alloy powder.

Patent Document 1 proposes charging and discharging a battery after fabrication while keeping the temperature of the battery constant, in order to make the surface condition of the Mg-containing hydrogen-absorbing alloy powder suited for battery reaction. However, performing a charge/discharge for activation after battery fabrication takes some time. In addition, it tends to cause variation of quality, thereby resulting in decreased productivity.

Therefore, in order to allow a freshly fabricated battery to have good performance, attempts have been made to activate a hydrogen-absorbing alloy powder before battery fabrication to facilitate the absorption and desorption of hydrogen.

For activation of a hydrogen-absorbing alloy powder, the use of an alkaline aqueous solution, acidic aqueous solution, hot water, and the like is generally believed to be effective. A specific method for activating the surface of a hydrogen-absorbing alloy powder is a method using an aqueous solution containing potassium hydroxide (KOH), sodium hydroxide (NaOH), or the like at a high concentration. In this method, using such an aqueous solution, constituent elements of a nickel (Ni) containing hydrogen-absorbing alloy powder, such as Ni and rare-earth elements, are partially leached from the hydrogen-absorbing alloy powder to form a Ni concentrated layer on the surface of the hydrogen-absorbing alloy powder.

However, according to this method, oxides and hydroxides of rare-earth elements are produced on the surface of the hydrogen-absorbing alloy powder. Since oxides and hydroxides of rare-earth elements are electrical insulators, they become a cause of inhibition of battery reaction.

Therefore, Patent Document 2 describes a method in which a hydrogen-absorbing alloy powder is immersed in a hot alkaline aqueous solution to form a Ni rich layer on the surface of the hydrogen-absorbing alloy powder. According to this method, a strongly alkaline aqueous solution adjusted to a pH of 14 or more is used as the alkaline aqueous solution. Specifically, a mixed solution containing KOH and at least one of lithium hydroxide (LiOH) and NaOH is used.

Also, Patent Document 3 describes a method in which a hydrogen-absorbing alloy powder is immersed in a boiling KOH aqueous solution containing LiOH or a boiling NaOH aqueous solution containing LiOH to modify the surface condition of the hydrogen-absorbing alloy powder.

### CITATION LIST

### Patent Document

Patent Document 1: Japanese Laid-Open Patent Publication No. 2007-87886

Patent Document 2: Japanese Laid-Open Patent Publication No. 2000-021400

Patent Document 3: Japanese Laid-Open Patent Publication No. Hei 7-029568

### DISCLOSURE OF THE INVENTION

### Problem to be Solved by the Invention

However, the methods of Patent Documents 2 and 3 cause not only the activation of a hydrogen-absorbing alloy powder but also a corrosion or particle cracking. Corrosion or particle cracking is a cause of deterioration of the hydrogen-absorbing alloy powder, and can shorten battery life. Also, according to activation methods not utilizing electrochemical reaction, leached elements may not be controlled. In particular, in the case of a hydrogen-absorbing alloy powder containing magnesium (Mg), its surface is often not activated as desired. Further, since the oxides and hydroxides of rare-earth elements deposited on the alloy surface are not completely removed, a cause of inhibition of battery reaction remains unremoved. Hence, the discharge characteristics of the alkaline storage battery are not sufficiently improved.

The invention has been achieved in view of the problems as noted above. An object of the invention is to remove oxides and hydroxides precipitated on the surface of a hydrogen-absorbing alloy powder with a simple means and within a short period of time, thereby providing a hydrogen-absorbing alloy powder with a favorably activated surface condition.

### Means for Solving the Problem

The invention relates to a method for treating the surface of a hydrogen-absorbing alloy powder. This method includes: (i) a first step of stirring a first mixture that includes a hydrogen-absorbing alloy powder containing Ni and Mg and having a Ni content of 35 to 60% by weight and a lithium hydroxide aqueous solution; and (ii) a second step of stirring a second mixture that includes the hydrogen-absorbing alloy powder subjected to the first step and an alkali metal hydroxide aqueous solution of at least one of sodium hydroxide and potassium hydroxide.

The method for treating the surface of a hydrogen-absorbing alloy powder is particularly effective when using a hydrogen-absorbing alloy powder containing Ni or Mg, making it possible to provide an alkaline storage battery with excellent characteristics.

In the method for treating the surface of a hydrogen-absorbing alloy powder, the lithium hydroxide aqueous solution used in the first step preferably has a lithium hydroxide concentration of 0.1 to 8 mol/L.

In the method for treating the surface of a hydrogen-absorbing alloy powder, the alkali metal hydroxide aqueous solution used in the second step preferably contains sodium hydroxide, with a sodium hydroxide concentration of 7 to 20 mol/L.

Also, the alkali metal hydroxide aqueous solution used in the second step preferably contains potassium hydroxide, with a potassium hydroxide concentration of 5 to 13 mol/L.

In the method for treating the surface of a hydrogen-absorbing alloy powder, the first mixture in the first step preferably has a temperature of 50 to 150° C.

Also, in the method for treating the surface of a hydrogen-absorbing alloy powder, the second mixture in the second step preferably has a temperature of 50 to 150° C.

The invention is particularly effective when the hydrogen-absorbing alloy has a crystal structure of Ce₂Ni₇ type or CeNi₃ type.

The invention also pertains to a hydrogen-absorbing alloy powder subjected to the above-described method for treating the surface of a hydrogen-absorbing alloy powder.

The invention also relates to a negative electrode for an alkaline storage battery including the above-mentioned hydrogen-absorbing alloy powder.

The invention is also directed to an alkaline storage battery including a positive electrode including nickel, the above-mentioned negative electrode for an alkaline storage battery, and an alkaline electrolyte.

### Effects of the Invention

According to the invention, a hydrogen-absorbing alloy powder can be sufficiently activated in a short period of time. The use of a hydrogen-absorbing alloy powder subjected to a surface treatment by the method of the invention can provide an alkaline storage battery with excellent discharge characteristics (in particular, low-temperature discharge performance).

### BRIEF DESCRIPTION OF THE DRAWING

FIG. 1 is a longitudinal sectional view of a nickel metal hydride storage battery according to an Example.

### MODE FOR CARRYING OUT THE INVENTION

The method for treating the surface of a hydrogen-absorbing alloy powder according to the invention includes:

(i) a first step of stirring a first mixture that includes a hydrogen-absorbing alloy powder containing Ni and Mg and having a Ni content of 35 to 60% by weight and a LiOH aqueous solution; and

(ii) a second step of stirring a second mixture that includes the hydrogen-absorbing alloy powder subjected to the first step and an alkali metal hydroxide aqueous solution of at least one of NaOH and KOH.

Hydrogen-absorbing alloys suited for the surface treatment by the above method include, for example, so-called AB₃ type alloys which contain Ni and Mg and have a Ni content of 35 to 60% by weight.

AB₃ type alloys have a crystal structure of Ce₂Ni₇ type or CeNi₃ type. AB₃ type alloys have high reactivity of hydrogenation at room temperature and are preferable in that they can be used as high capacity negative electrode materials.

Specific examples of AB₃ type alloys containing Ni and Mg and having a Ni content of 35 to 60% by weight include La_{0.7}Mg_{0.3}Ni_{2.75}Co_{0.5}Al_{0.05}, La_{0.6}Mg_{0.4}Ni_{2.75}Co_{0.5}Al_{0.05}, and La_{0.7}Mg_{0.3}Ni_{2.75}Co_{0.4}Al_{0.05}.

In the hydrogen-absorbing alloys suitable for the surface treatment method of the invention, the Ni content is 35 to 60% by weight, as described above. In this range, 40 to 55% by weight is particularly preferable. When the Ni content in the hydrogen-absorbing alloy is set in this range, the reactivity of hydrogenation of the hydrogen-absorbing alloy powder can be significantly improved. It is therefore possible to increase the amount of hydrogen absorbed in the hydrogen-absorbing alloy powder and hence the battery capacity.

If the Ni content is less than 35% by weight, the initiation sites for hydrogen-absorbing reaction decrease, and absorption and desorption of hydrogen are unlikely to occur. If the Ni content exceeds 60% by weight, such composition is significantly different from an ideal composition, and the amount of hydrogen absorbed in the hydrogen-absorbing alloy powder decreases significantly.

The Mg content in the hydrogen-absorbing alloy is preferably 0.01 to 6% by weight, and more preferably 0.05 to 3% by weight. When the Mg content is set in the above range, the amount of hydrogen absorbed can be further increased. If the Mg content exceeds 6% by weight, Mg is subject to segregation in the hydrogen-absorbing alloy, and the corrosion of the hydrogen-absorbing alloy powder by alkaline electrolyte may be promoted.

It is preferable that the hydrogen-absorbing alloy contain, for example, one or more rare-earth metal elements, cobalt (Co), aluminum (Al), or manganese (Mn) in addition to Ni and Mg. Co has the effect of enhancing the corrosion resistance of the hydrogen-absorbing alloy powder. Both Al and Mn have the effect of lowering the hydrogen equilibrium pressure in the hydrogen absorbing reaction.

In terms of increasing the reactivity of hydrogenation of the hydrogen-absorbing alloy powder, it is effective to make the amount of Ni sites greater than stoichiometric composition. For example, in the case of a hydrogen-absorbing alloy powder with a Ce₂Ni₇ type crystal structure, it is effective to set the molar ratio to Ce:Ni=2:x where 7<x.

The mean particle size (volume basis median diameter, determined by laser diffraction particle size analysis; hereinafter the same) of the hydrogen-absorbing alloy powder is not particularly limited, but it is preferably, for example, 5 to 30 μm. If the mean particle size is too small, the surface area of the hydrogen-absorbing alloy powder may become too large, thereby resulting in decreased corrosion resistance. If the mean particle size is too large, the surface area of the hydrogen-absorbing alloy powder may become too small, thereby impeding the hydrogen absorbing reaction.

In the first step of the above surface treatment method, a LiOH aqueous solution is used to stir the hydrogen-absorbing alloy powder. LiOH, which contains lithium of high ionization tendency, is readily ionized in an aqueous solution. In addition, the LiOH aqueous solution easily dissolves Mg, and is superior in the ability to leach Mg segregated in the hydrogen-absorbing alloy and thereby remove it from the hydrogen alloy powder, although the detailed reason is not yet clear.

Thus, by stirring the hydrogen-absorbing alloy powder in the LiOH aqueous solution as the first step of the surface treatment, Mg segregated in the hydrogen-absorbing alloy powder (i.e., unevenly distributed near the surface of the hydrogen-absorbing alloy powder) can be removed from the hydrogen-absorbing alloy powder. As a result, the Mg content near the surface of the hydrogen-absorbing alloy powder can be lowered.

Examples of leached-out elements in the first step include a Mg ion (Mg²⁺), light rare-earth metal ions, and a complex anion. Specifically, they differ with the composition of the hydrogen-absorbing alloy. For example, when the hydrogen-absorbing alloy is represented by the general formula: Mm_{1-y}Mg_{y}Ni₅₋ₓMₓ, a lanthanum (III) ion (La³⁺), a neodymium (III) ion (Nd³⁺), a cerium (III) ion (Ce³⁺), divalent to heptavalent Mn ions, and a complex anion (e.g., CoO₂ or AlO₂) leach out in the first step.

In the first step, the leaching of constituent elements of the hydrogen-absorbing alloy results in increased specific surface area of the hydrogen-absorbing alloy powder, thereby promoting activation. On the other hand, the leaching reaction produces a liquid containing the leached constituent elements. From this liquid, mainly hydroxides of light rare-earth metals such as Ce(OH)₃ and La(OH)₃ and Mn-containing composite oxides are re-precipitated on the surface of the hydrogen-absorbing alloy powder. When the re-precipitate accumulates thereon, the leaching speed of metal elements in the first step lowers sharply.

The LiOH concentration of the LiOH aqueous solution used in the first step is preferably 0.1 to 8 mol/L, and more preferably 1 to 6 mol/L. If the LiOH concentration is lower than the above range, the surface treatment of the hydrogen-absorbing alloy powder may not proceed sufficiently. If the LiOH concentration is higher than the above range, LiOH is more likely to be precipitated; even if the aqueous solution has a high temperature, part of LiOH may be precipitated. Hence, the efficiency of the surface treatment may lower, or the reproducibility of the effect obtained by the first step may be impaired.

It is preferable that the LiOH aqueous solution used in the first step contain no NaOH or KOH. Also, should the LiOH aqueous solution contain NaOH or KOH, it is preferable that the content thereof be such a very small amount as an impurity. That is, it is preferable that the LiOH aqueous solution contain substantially no NaOH or KOH. Specifically, the content of NaOH or KOH in the LiOH aqueous solution used in the first step is preferably 0.03 ppm or less.

The treatment temperature of the first step is preferably 50 to 150° C. Also, it is more preferably 80 to 120° C. in view of the material and structure of the facilities (e.g., stirring vessel) used in the surface treatment. If the treatment temperature is lower than the above range, the desired reaction is less likely to occur. If the treatment temperature is higher than the above range, the temperature of the LiOH aqueous solution reaches close to the boiling point, regardless of the OH⁻ ion concentration of the LiOH aqueous solution. Thus, problems resulting from bumping or the like may occur.

The treatment time of the first step is set as appropriate, depending on the amount of the hydrogen-absorbing alloy powder subjected to the surface treatment. Hence, the treatment time of the first step is not limited, but the preferable treatment time is usually 10 to 120 minutes.

The treatment (first step) using the LiOH aqueous solution has a high treatment speed in an early stage. In addition, due to the above reason, the leaching speed of metal elements decreases in a relatively early stage, and the effect of dissolving Mg lowers. Thus, it is particularly preferable to set the treatment time of the first step within the above range.

In the second step of the above surface treatment method, a NaOH aqueous solution or KOH aqueous solution is used to stir the hydrogen-absorbing alloy powder. Both NaOH and KOH are readily ionized in an aqueous solution. In addition, the NaOH aqueous solution and KOH aqueous solution are highly effective in removing oxides and hydroxides from the hydrogen-absorbing alloy powder. Therefore, by using the NaOH aqueous solution or KOH aqueous solution to stir the hydrogen-absorbing alloy powder subjected to the first step for surface treatment, most of the oxides and hydroxides precipitated on the hydrogen-absorbing alloy powder can be efficiently removed.

The second step is performed subsequently to the first step. That is, after the surface treatment with the LiOH aqueous solution in the first step, the mixture of the hydrogen-absorbing alloy powder and the LiOH aqueous solution is allowed to stand to settle the hydrogen-absorbing alloy powder, and the supernatant LiOH aqueous solution is removed. Subsequently, in the second step, the residue (the hydrogen-absorbing alloy powder subjected to the surface treatment with the LiOH aqueous solution) left after the removal of the supernatant fluid is stirred in the NaOH aqueous solution or KOH aqueous solution for surface treatment. Thereafter, the mixture of the hydrogen-absorbing alloy powder and the NaOH aqueous solution or KOH aqueous solution is allowed to stand to settle the hydrogen-absorbing alloy powder, and the supernatant NaOH aqueous solution or KOH aqueous solution is removed.

Since NaOH or KOH used in the second step has a lower degree of ionization than LiOH, it is less capable of leaching constituent elements of the hydrogen-absorbing alloy powder than LiOH.

However, NaOH or KOH is highly capable of dissolving the re-precipitate on the surface of the hydrogen-absorbing alloy powder or removing it from the surface, compared with LiOH. Also, the NaOH aqueous solution or KOH aqueous solution can provide a higher OH⁻ ion concentration than the LiOH aqueous solution. As such, the second step can impart high activity to the hydrogen-absorbing alloy powder in a short-time treatment.

In the second step of stirring the hydrogen-absorbing alloy powder in the NaOH aqueous solution or KOH aqueous solution for surface treatment, the mixture (second mixture) containing the hydrogen-absorbing alloy powder and the aqueous solution of at least one of NaOH and KOH may contain LiOH used in the first step.

In the case of using the NaOH aqueous solution in the second step, the NaOH concentration of the NaOH aqueous solution is preferably 7 to 20 mol/L, and more preferably 10 to 18 mol/L. If the NaOH concentration is lower than the above range, the re-precipitate may not be sufficiently removed, and the efficiency of the surface treatment may lower. If the NaOH concentration is higher than the above range, the precipitation of NaOH may be promoted. Thus, the productivity of the surface treatment may lower, or the reproducibility of the effect obtained by the second step may be impaired.

In the case of using the KOH aqueous solution in the second step, the KOH concentration of the KOH aqueous solution is preferably 5 to 13 mol/L, and more preferably 8 to 10 mol/L. If the KOH concentration is lower than the above range, the re-precipitate may not be sufficiently removed, and the efficiency of the surface treatment may lower. If the KOH concentration is higher than the above range, the precipitation of KOH may be promoted. Thus, the productivity of the surface treatment may lower, or the reproducibility of the effect obtained by the second step may be impaired.

The treatment temperature of the second step is preferably 50 to 150° C. in either case of using the NaOH aqueous solution or the KOH aqueous solution in the second step. Also, it is more preferably 80 to 120° C. in view of the material and structure of the facilities (e.g., stirring vessel) used in the surface treatment. If the treatment temperature is lower than the above range, the desired reaction is less likely to occur. If the treatment temperature is higher than the above range, the temperature of the aqueous solution reaches close to the boiling point, regardless of the OH⁻ ion concentration of the NaOH aqueous solution or KOH aqueous solution. Thus, problems resulting from bumping or the like may occur.

The treatment time of the second step is set as appropriate, depending on the amount of the hydrogen-absorbing alloy powder subjected to the surface treatment and the temperature and concentration of the NaOH aqueous solution or KOH aqueous solution. Hence, the treatment time of the second step is not limited, but the preferable treatment time is usually 10 to 120 minutes.

The surface treatment of the second step will proceed faster than the surface treatment of the first step. Also, the speed of the surface treatment of the second step correlates closely with the temperature and concentration of the NaOH aqueous solution or KOH aqueous solution. Specifically, as the temperature and concentration of the NaOH aqueous solution or KOH aqueous solution become higher, the speed of the surface treatment of the second step increases, so the treatment time can be shortened.

According to the above surface treatment method, by performing the first step and the second step, the removal of Mg segregated in the hydrogen-absorbing alloy and the removal of the oxides and hydroxides precipitated on the surface of the hydrogen-absorbing alloy powder can be achieved with a simple method. In addition, desired degree of activation can be achieved by a short-time treatment. That is, the hydrogen-absorbing alloy powder can be sufficiently activated within a short period of time.

As described above, by performing the second step after the first step, it is possible to utilize the advantageous property of the LiOH aqueous solution and the advantageous property of the NaOH aqueous solution or KOH aqueous solution, while compensating for the disadvantageous properties thereof. As a result, the activation of the hydrogen-absorbing alloy powder and the removal of the re-precipitate can be carried out simultaneously.

According to the above surface treatment method for a hydrogen-absorbing alloy powder, the first step is followed by the second step. Performing these two steps in stages can also produce the effect of facilitating the comprehensive process control of the surface treatment.

The hydrogen-absorbing alloy powder of the invention has been subjected to the surface treatment by the first step and the subsequent surface treatment by the second step.

As a result of such surface treatment, the oxygen concentration of the hydrogen-absorbing alloy powder will be lowered to 1.10% by weight or less. The use of a hydrogen-absorbing alloy powder with such a lowered oxygen concentration allows an alkaline storage battery to have excellent discharge characteristics.

As used herein, “oxygen concentration” refers to the oxygen concentration determined by the oxygen concentration measurement method (infrared absorption method) defined in JIS Z 2613, which corresponds to the amount of oxides or hydroxides precipitated on the surface of the hydrogen-absorbing alloy powder.

The oxygen concentration of the hydrogen-absorbing alloy powder is preferably 1.10% by weight or less of the above range, and more preferably 0.95% by weight or less.

If the oxygen concentration is higher than the above range, the discharge characteristics of the alkaline storage battery using such a hydrogen-absorbing alloy powder may be impaired. The lower limit of the oxygen concentration is usually, but not particularly limited to, approximately 0.8% by weight.

Also, as a result of the above surface treatment, the content of magnetic material in the hydrogen-absorbing alloy powder is adjusted to preferably 1.30% by weight or more. The use of a hydrogen-absorbing alloy powder with such an adjusted magnetic material content allows an alkaline storage battery to have excellent discharge characteristics.

Examples of magnetic material in the hydrogen-absorbing alloy powder include Ni and Co.

The content of magnetic material can be determined, for example, by a vibrating sample magnetometer.

The content of magnetic material in the hydrogen-absorbing alloy powder is preferably 1.30% by weight or more and 2.30% by weight or less of the above range, more preferably 1.55% by weight or more and 2.30% by weight or less, and most preferably 1.75% by weight to 2.30% by weight.

If the content of magnetic material is less than the above range, the discharge characteristics of the alkaline storage battery using such a hydrogen-absorbing alloy powder may be impaired. The upper limit of the content of magnetic material is not particularly limited; however, if it is greater than the above range, the capacity tends to decrease due to a decrease in the content of a hydrogen-absorbing alloy.

The negative electrode for an alkaline storage battery according to the invention includes the hydrogen-absorbing alloy powder treated with the above-described surface treatment method as an essential component, and further includes optional components such as a conductive agent, a thickener, and a binder. The negative electrode is prepared by forming a negative electrode mixture including the above hydrogen-absorbing alloy powder into a predetermined shape, or by preparing a negative electrode mixture paste including the above hydrogen-absorbing alloy powder, applying it onto a current collector (core member), and drying it.

The conductive agent is not particularly limited except that it should be an electron-conductive material, and various electron-conductive materials can be used. Specific examples include graphites such as natural graphite (e.g., flake graphite), artificial graphite, and expanded graphite, carbon blacks such as acetylene black, ketjen black, channel black, furnace black, lamp black, and thermal black, conductive fibers such as carbon fiber and metal fiber, metal powders such as copper powder, and organic conductive materials such as polyphenylene derivatives. Among them, artificial graphite, ketjen black, and carbon fiber are preferable. These electron-conductive materials can be used singly or as a mixture of two or more. Also, these electron-conductive materials may be used to cover the surface of the hydrogen-absorbing alloy powder.

The amount of the conductive agent added is not particularly limited; however, for example, it is preferably 0.1 to 50 parts by weight per 100 parts by weight of the hydrogen-absorbing alloy powder, and more preferably 0.1 to 30 parts by weight.

The thickener imparts viscosity to the negative electrode mixture paste. For example, when water is used as the dispersion medium of the negative electrode mixture paste, carboxymethyl cellulose (CMC), modified CMC, polyvinyl alcohol, methyl cellulose, polyethylene oxide, or the like can be used as the thickener.

The binder has the function of bonding the hydrogen-absorbing alloy powder or conductive agent to the current collector. The binder may be either a thermoplastic resin or a thermosetting resin. Examples of such binders include styrene-butadiene copolymer rubber (SBR), polyethylene, polypropylene, polytetrafluoroethylene, polyvinylidene fluoride, tetrafluoroethylene-hexafluoropropylene copolymer, tetrafluoroethylene-perfluoroalkylvinylether copolymer, vinylidene fluoride-hexafluoropropylene copolymer, vinylidene fluoride-chlorotrifluoroethylene copolymer, ethylene-tetrafluoroethylene copolymer, polychlorotrifluoroethylene, vinylidene fluoride-pentafluoropropylene copolymer, propylene-tetrafluoroethylene copolymer, ethylene-chlorotrifluoroethylene copolymer, vinylidene fluoride-hexafluoropropylene-tetrafluoroethylene copolymer, vinylidene fluoride-perfluoromethylvinylether-tetrafluoroethylene copolymer, ethylene-acrylic acid copolymer, ethylene-acrylic acid copolymer cross-linked with a Na⁺ ion, ethylene-methacrylic acid copolymer, ethylene-methacrylic acid copolymer cross-linked with a Neion, ethylene-methyl acrylate copolymer, ethylene-methyl acrylate copolymer cross-linked with a Na⁺ ion, ethylene-methyl methacrylate copolymer, and ethylene-methyl methacrylate copolymer cross-linked with a Na⁺ ion. They can be used singly or as a mixture of two or more.

The alkaline storage battery of the invention includes a positive electrode, the above-described negative electrode for an alkaline storage battery, and an alkali electrolyte. Also, a separator is usually disposed between the positive electrode and the negative electrode.

The use of the above-described negative electrode for an alkaline storage battery can provide an alkaline storage battery that is excellent particularly in discharge performance.

Also, examples of alkaline storage batteries of the invention include nickel metal hydride storage batteries.

With respect to the positive electrode, various positive electrodes known in the field of the invention can be used. A specific example is a known sintered nickel positive electrode.

With regard to the alkaline electrolyte, various alkaline electrolytes known in the field of the invention can be used. A specific example is a potassium hydroxide aqueous solution containing lithium hydroxide at a concentration of 40 g/L and having a specific gravity of 1.30.

As for the separator, various separators known in the field of the invention can be used. A specific example is a polypropylene non-woven fabric.

### Examples

The invention is hereinafter described in detail with reference to examples in which nickel metal hydride storage batteries were produced.

### <Surface Treatment of Hydrogen-Absorbing Alloy Powder and Production of Nickel Metal Hydride Storage Battery>

### Example 1

A hydrogen-absorbing alloy represented by the compositional formula Mm_{0.7}Mg_{0.3}Ni_{2.75}Co_{0.5}Al_{0.05} (Mm represents misch metal; hereinafter the same) was introduced into a wet ball mill, and crushed in water to obtain a powder with a mean particle size of 30 μm (measurement method: laser diffraction method; hereinafter the same). This hydrogen-absorbing alloy powder serving as a raw material had a CeNi₃ type crystal structure, with a Ni content of 53% by weight and a Mg content of 2% by weight.

### (i) First Step

10 kg of the raw material hydrogen-absorbing alloy powder was introduced into a stirring vessel, and 3 kg of a LiOH aqueous solution with a concentration of 5 mol/L was introduced therein. The mixture of the hydrogen-absorbing alloy powder and the LiOH aqueous solution (hereinafter “first mixture”) was stirred for 10 minutes by rotating the stirring blades of the stirring vessel (first step). In the first step, the temperature inside the stirring vessel was suitably controlled by a heating means, so that the temperature of the first mixture was adjusted to a constant temperature of 90° C.

After the completion of the first step, the first mixture was allowed to stand to settle the hydrogen-absorbing alloy powder, and the supernatant LiOH aqueous solution was removed from the stirring vessel.

### (ii) Second Step

After the removal of the supernatant fluid (LiOH aqueous solution), 6 kg of a 18 mol/L NaOH aqueous solution was introduced into the stirring vessel. The mixture of the hydrogen-absorbing alloy powder, the NaOH,aqueous solution, and the LiOH aqueous solution remaining in the stirring vessel (this mixture is referred to as a “second mixture” in this Example and Examples 2 to 12 described below) was stirred for 10 minutes by stirring the stirring blades (second step). In the second step, the temperature inside the stirring vessel was suitably controlled by a heating means, so that the temperature of the second mixture was adjusted to a constant temperature of 90° C. The content of LiOH in the second mixture was 0.03 μg/g or less per unit weight of the second mixture.

After the completion of the second step, the second mixture was introduced into a pressure filter, and filtrated under a pressure of 5 kgf/cm² to remove the NaOH aqueous solution. The residue was then washed with a large amount of water to obtain the surface-treated hydrogen-absorbing alloy powder.

(iii) Preparation of Negative Electrode

To 10 kg of the hydrogen-absorbing alloy powder prepared in the second step were added 1 kg of a 1.5 wt % carboxymethyl cellulose (CMC) aqueous solution and 40 g of ketjen black. The resultant mixture was kneaded. Subsequently, 175 g of a styrene-butadiene rubber (SBR) dispersion with a solid content of 40% by weight was added thereto, and the resultant mixture was stirred to form a negative electrode mixture paste.

The negative electrode mixture paste thus obtained was applied onto both sides of a punched metal (core member), dried, and pressed to produce a negative electrode (hydrogen-absorbing alloy negative electrode) with a width of 35 mm and a thickness of 0.4 mm. The punched metal was made of iron plated with nickel, and had a thickness of 60 μm, a punched hole diameter of 1 mm, and an open area percentage of 42%. Also, one end of the negative electrode along the longitudinal direction was provided with an area where the core member was exposed.

This negative electrode had a theoretical capacity of 2200 mAh.

### (iv) Production of Nickel Metal Hydride Storage Battery

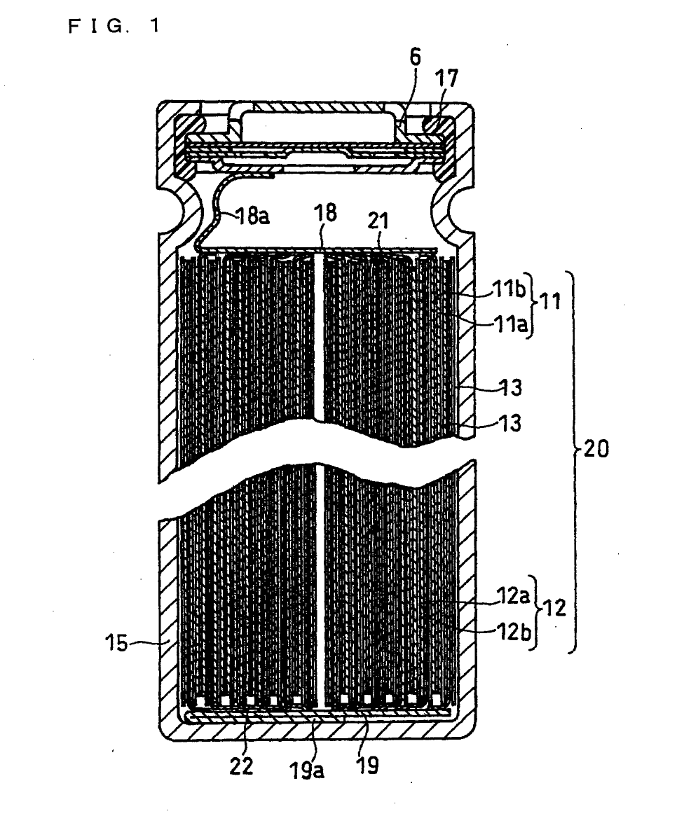

FIG. 1 is a longitudinal sectional view of a nickel metal hydride storage battery produced in this Example.

A negative electrode 12 was the above-described hydrogen-absorbing alloy negative electrode. A positive electrode 11 was a known sintered nickel positive electrode one end of which along the longitudinal direction was provided with an area where the core member was exposed. The positive electrode 11 had a theoretical capacity of 1500 mAh. A separator 13 was a polypropylene non-woven fabric. Also, an alkaline electrolyte was prepared by dissolving lithium hydroxide at a concentration of 40 g/L in a potassium hydroxide aqueous solution with a specific gravity of 1.30.

The nickel metal hydride storage battery was produced in the following manner. First, the positive electrode 11 and the negative electrode 12 were wound with the separator 13 interposed therebetween, to produce a cylindrical electrode group 20. It should be noted that the positive electrode 11 had the exposed area where a positive electrode mixture 11a was not applied and a positive electrode core member 11b was exposed, and that the negative electrode 12 had the exposed area where a negative electrode mixture 12a was not applied and a negative electrode core member 12b was exposed. In fabricating the electrode group 20, these exposed areas of the positive electrode 11 and the negative electrode 12 were disposed on the opposite end faces of the electrode group 20 in the axial direction thereof. A positive electrode current collector plate 18 was welded to an end face 21 of the electrode group 20 where the positive electrode core member 11b was exposed, while a negative electrode current collector plate 19 was welded to an end face 22 of the electrode group 20 where the negative electrode core member 12b was exposed.

Subsequently, the electrode group 20 was placed in a cylindrical battery case 15 with a bottom from the negative electrode current collector plate 19 side. The battery case 15 is a member used as also the negative electrode terminal. A negative electrode lead 19a had been welded to the bottom of the battery case 15 in advance. Through the negative electrode lead 19a, the negative electrode current collector plate 19 and the battery case 15 were electrically connected.

Thereafter, an electrolyte was injected into the battery case 15, and the opening of the battery case 15 was sealed with a seal plate 6 the circumference of which was fitted with a gasket 17. The seal plate 6 is a member used as also the positive electrode terminal. A positive electrode lead 18a had been welded to the inner surface of the seal plate 6 inside the battery case 15 in advance. Through the positive electrode lead 18a, the positive electrode current collector plate 18 and the seal plate 6 were electrically connected.

In this way, a nickel metal hydride storage battery of 4/5A size (a diameter of approximately 17 mm and a length of approximately 43 mm) with a nominal capacity of 1500 mAh was produced.

### Examples 2 to 7

Nickel metal hydride storage batteries were produced in the same manner as in Example 1, except that the LiOH concentration of the LiOH aqueous solution in the first step was set to 0.05 mol/L in Example 2, 0.1 mol/L in Example 3, 1 mol/L in Example 4, 6 mol/L in Example 5, 8 mol/L in Example 6, and 10 mol/L in Example 7.

### Examples 8 to 12

Nickel metal hydride storage batteries were produced in the same manner as in Example 1, except that the NaOH concentration of the NaOH aqueous solution in the second step was set to 5 mol/L in Example 8, 7 mol/L in Example 9, 10 mol/L in Example 10, 20 mol/L in Example 11, and 25 mol/L in Example 12.

### Examples 13 to 17

Nickel metal hydride storage batteries were produced in the same manner as in Example 1, except that the temperature of the first mixture in the first step and the temperature of the second mixture in the second step were set to 40° C. (Example 13), 50° C. (Example 14), 80° C. (Example 15), 120° C. (boiling state, Example 16), or 150° C. (boiling state, Example 17).

### Comparative Example 1

10 kg of a raw material hydrogen-absorbing alloy powder, which was the same as that of Example 1, was introduced into a stirring vessel, and then, 6 kg of a NaOH aqueous solution with a concentration of 18 mol/L was introduced therein. The mixture of the hydrogen-absorbing alloy powder and the NaOH aqueous solution was stirred for 20 minutes by rotating the stirring blades of the stirring vessel. During the stirring, the temperature inside the stirring vessel was suitably controlled by a heating means, so that the temperature of the mixture was adjusted to a constant temperature of 90° C.

After the stirring, the mixture in the stirring vessel was allowed to stand to settle the hydrogen-absorbing alloy powder, and the supernatant NaOH aqueous solution was removed from the stirring vessel. Subsequently, the deposit was washed with a large amount of water, to obtain the surface-treated hydrogen-absorbing alloy powder. That is, in Comparative Example 1, the first step of Example 1 (the treatment with the LiOH aqueous solution) was not performed, and only the second step (the treatment with the NaOH aqueous solution) was performed and the treatment time was set to 20 minutes.

A nickel metal hydride storage battery was produced in the same manner as in Example 1 except for the use of the surface-treated hydrogen-absorbing alloy powder thus obtained.

### Comparative Example 2

10 kg of a raw material hydrogen-absorbing alloy powder, which was the same as that of Example 1, was introduced into a stirring vessel. Subsequently, an aqueous solution comprising a mixture of 1.5 kg of a LiOH aqueous solution with a concentration of 5 mol/L and 3 kg of a NaOH aqueous solution with a concentration of 18 mol/L was introduced into the stirring vessel. The mixture of the hydrogen-absorbing alloy powder and the mixed aqueous solution was stirred for 20 minutes by rotating the stirring blades of the stirring vessel. During the stirring, the temperature inside the stirring vessel was suitably controlled by a heating means, so that the temperature of the mixture was adjusted to a constant temperature of 90° C.

After the stirring, the mixture in the stirring vessel was allowed to stand to settle the hydrogen-absorbing alloy powder, and the supernatant mixed aqueous solution of LiOH and NaOH was removed from the stirring vessel. Subsequently, the deposit was washed with a large amount of water, to obtain the surface-treated hydrogen-absorbing alloy powder.

A nickel metal hydride storage battery was produced in the same manner as in Example 1 except for the use of the surface-treated hydrogen-absorbing alloy powder thus obtained.

### Comparative Example 3

10 kg of a raw material hydrogen-absorbing alloy powder, which was the same as that of Example 1, was introduced into a stirring vessel. Subsequently, an aqueous solution comprising a mixture of 1 kg of a LiOH aqueous solution with a concentration of 5 mol/L, 2 kg of a NaOH aqueous solution with a concentration of 18 mol/L, and 2 kg of a KOH aqueous solution with a concentration of 10 mol/L was introduced into the stirring vessel. The mixture of the hydrogen-absorbing alloy powder and the mixed aqueous solution was stirred for 20 minutes by rotating the stirring blades of the stirring vessel. During the stirring, the temperature inside the stirring vessel was suitably controlled by a heating means, so that the temperature of the mixture was adjusted to a constant temperature of 90° C.

After the stirring, the mixture in the stirring vessel was allowed to stand to settle the hydrogen-absorbing alloy powder, and the supernatant mixed aqueous solution of LiOH, NaOH, and KOH was removed from the stirring vessel. Subsequently, the deposit was washed with a large amount of water, to obtain the surface-treated hydrogen-absorbing alloy powder.

A nickel metal hydride storage battery was produced in the same manner as in Example 1 except for the use of the surface-treated hydrogen-absorbing alloy powder thus obtained.

### Comparative Example 4

10 kg of a raw material hydrogen-absorbing alloy powder, which was the same as that of Example 1, was introduced into a stirring vessel, and then, 3 kg of a LiOH aqueous solution with a concentration of 5 mol/L was introduced therein. The mixture (first mixture) of the hydrogen-absorbing alloy powder and the LiOH aqueous solution was stirred for 20 minutes by rotating the stirring blades of the stirring vessel. During the stirring, the temperature inside the stirring vessel was suitably controlled by a heating means, so that the temperature of the first mixture was adjusted to a constant temperature of 90° C.

After the stirring, the first mixture was allowed to stand to settle the hydrogen-absorbing alloy powder, and the supernatant LiOH aqueous solution was removed from the stirring vessel. Subsequently, the deposit was washed with a large amount of water, to obtain the surface-treated hydrogen-absorbing alloy powder. That is, in Comparative Example 4, the treatment time of the first step (the treatment with the LiOH aqueous solution) was set to 20 minutes, and the second step (the treatment with the NaOH aqueous solution) was not performed.

A nickel metal hydride storage battery was produced in the same manner as in Example 1 except for the use of the surface-treated hydrogen-absorbing alloy powder thus obtained.

### Comparative Example 5

A surface-treated hydrogen-absorbing alloy powder was prepared in the same manner as in Comparative Example 2, except that during the stirring, the temperature of the mixture in the stirring vessel was adjusted to a constant temperature of 120° C. (boiling state). A nickel metal hydride storage battery was produced in the same manner as in Example 1 except for the use of the surface-treated hydrogen-absorbing alloy powder thus obtained.

### <Evaluation of Physical Properties>

With respect to Examples 1 to 17 and Comparative Examples 1 to 5, the following measurements were made to evaluate the physical properties of their surface-treated hydrogen-absorbing alloy powders and the nickel metal hydride storage batteries using these alloy powders.

### Amount of Magnetic Material

Each of the surface-treated hydrogen-absorbing alloy powders was dried, and the concentration of metallic magnetic material in the hydrogen-absorbing alloy powder was measured with a vibrating sample magnetometer (VSM available from TOEI INDUSTRY CO., LTD.). The measured values are shown in the following Tables 1 to 3 as the weight ratio (% by weight) of magnetic material in the hydrogen-absorbing alloy powder.

### Oxygen Concentration

The oxygen concentration of each of the surface-treated hydrogen-absorbing alloy powders was measured according to the oxygen concentration measurement method (infrared absorption method) defined in JIS Z 2613. Specifically, the amount of oxygen was determined by introducing the gas extracted from each sample (surface-treated hydrogen-absorbing alloy powder) into an infrared absorption cell and measuring the change in the amount of infrared absorption. The measured values are shown in the following Tables 1 to 3 as the weight ratio (% by weight) of oxygen in the hydrogen-absorbing alloy powder.

### Initial Discharge Capacity and Low-Temperature Discharge Performance

Each of the nickel metal hydride storage batteries was charged to 120% of the theoretical capacity at a current value of 1.5 A in a 20° C. environment. The charged nickel metal hydride storage battery was then discharged at a current value of 3.0 A in a 20° C. environment until the battery voltage lowered to 1.0 V, to measure the discharge capacity (initial discharge capacity, unit: mAh).

Further, after the measurement of the initial discharge capacity, the nickel metal hydride storage battery was charged to 120% of the theoretical capacity at a current value of 1.5 A in a 20° C. environment. The charged nickel metal hydride storage battery was then discharged at a current value of 3.0 A in a 0° C. environment until the battery voltage lowered to 1.0 V, to measure the discharge capacity (low-temperature discharge capacity, unit: mAh). The ratio (%) of the low-temperature discharge capacity to the initial discharge capacity was used as a measure of low-temperature discharge performance.

The above measurement results are shown in the following Tables 1 to 3.

TABLE 1

| | | | Magnetic | | Initial | Low-temperature |
|---|---|---|---|---|---|---|
| | <First step> | <Second step> | material | Oxygen | discharge | discharge |
| | LiOH conc. | NaOH conc. | content | conc. | capacity | performance |
| | Treatment cond. | Treatment cond. | [wt %] | [wt %] | [mAh] | [%] |
| Comp. Ex. | — | 18 mol/L | 1.25 | 1.10 | 1200 | 64 |
| 1 | | 90° C., 20 min | C | C | C | C |
| Example 2 | 0.05 mol/L | 18 mol/L | 1.30 | 1.00 | 1240 | 70 |
| | 90° C., 10 min | 90° C., 10 min | B | B | B | B |
| Example 3 | 0.1 mol/L | 18 mol/L | 1.55 | 0.93 | 1320 | 83 |
| | 90° C., 10 min | 90° C., 10 min | A | A | A | A+ |
| Example | 1 mol/L | 18 mol/L | 1.75 | 0.85 | 1450 | 86 |
| 4 | 90° C., 10 min | 90° C., 10 min | A+ | A+ | A+ | A+ |
| Example | 5 mol/L | 18 mol/L | 1.90 | 0.75 | 1510 | 87 |
| 1 | 90° C., 10 min | 90° C., 10 min | A+ | A+ | A+ | A+ |
| Example | 6 mol/L | 18 mol/L | 2.10 | 0.77 | 1518 | 88 |
| 5 | 90° C., 10 min | 90° C., 10 min | A+ | A+ | A+ | A+ |
| Example | 8 mol/L | 18 mol/L | 2.31 | 0.65 | 1515 | 91 |
| 6 | 90° C., 10 min | 90° C., 10 min | A+ | A+ | A+ | A+ |
| Example | 10 mol/L | 18 mol/L | 2.34 | 0.70 | 1400 | 80 |
| 7 | 90° C., 10 min | 90° C., 10 min | A+ | A+ | A+ | A+ |

| | | | | | |
|---|---|---|---|---|---|
| Comp. Ex. | (LiOH + NaOH) aq. | 1.10 | 1.10 | 1200 | 54 |
| 2 | 90° C., 20 min | C | C | C | C |
| Comp. Ex. | (LiOH + NaOH + KOH) aq. | 1.15 | 1.30 | 1230 | 59 |
| 3 | 90° C., 20 min | C | C | C | C |

TABLE 2

| | | | Magnetic | | Initial | Low-temperature |
|---|---|---|---|---|---|---|
| | <First step> | <Second step> | material | Oxygen | discharge | discharge |
| | LiOH conc. | NaOH conc. | content | conc. | capacity | performance |
| | Treatment cond. | Treatment cond. | [wt %] | [wt %] | [mAh] | [%] |
| Comp. Ex. | 5 mol/L | — | 1.50 | 1.31 | 1280 | 63 |
| 4 | 90° C., 20 min | | B | C | C | C |
| Example | 5 mol/L | 5 mol/L | 1.58 | 1.00 | 1200 | 45 |
| 8 | 90° C., 10 min | 90° C., 10 min | B | B | B | B |
| Example | 5 mol/L | 7 mol/L | 1.62 | 0.98 | 1370 | 79 |
| 9 | 90° C., 10 min | 90° C., 10 min | A | A | A | A |
| Example | 5 mol/L | 10 mol/L | 1.80 | 0.90 | 1480 | 84 |
| 10 | 90° C., 10 min | 90° C., 10 min | A+ | A+ | A+ | A+ |
| Example | 5 mol/L | 18 mol/L | 1.90 | 0.75 | 1510 | 87 |
| 1 | 90° C., 10 min | 90° C., 10 min | A+ | A+ | A+ | A+ |
| Example | 5 mol/L | 20 mol/L | 1.95 | 0.64 | 1510 | 92 |
| 11 | 90° C., 10 min | 90° C., 10 min | A+ | A+ | A+ | A+ |
| Example | 5 mol/L | 25 mol/L | 2.00 | 0.70 | 1350 | 70 |
| 12 | 90° C., 10 min | 90° C., 10 min | A+ | A+ | A+ | A+ |

| | | | | | |
|---|---|---|---|---|---|
| Comp. Ex. | (LiOH + NaOH) aq. | 1.10 | 1.10 | 1200 | 54 |
| 2 | 90° C., 20 min | C | C | C | C |
| Comp. Ex. | (LiOH + NaOH + KOH) aq. | 1.15 | 1.30 | 1230 | 59 |
| 3 | 90° C., 20 min | C | C | C | C |

TABLE 3

| | | | Magnetic | | Initial | Low-temperature |
|---|---|---|---|---|---|---|
| | <First step> | <Second step> | material | Oxygen | discharge | discharge |
| | LiOH conc. | NaOH conc. | content | conc. | capacity | performance |
| | Treatment cond. | Treatment cond. | [wt %] | [wt %] | [mAh] | [%] |
| Example | 5 mol/L | 18 mol/L | 1.55 | 1.01 | 1150 | 70 |
| 13 | 40° C., 10 min | 40° C., 10 min | B | B | B | B |
| Example | 5 mol/L | 18 mol/L | 1.60 | 0.96 | 1350 | 80 |
| 14 | 50° C., 10 min | 50° C., 10 min | A | A | A | A+ |
| Example | 5 mol/L | 18 mol/L | 1.85 | 0.82 | 1490 | 86 |
| 15 | 80° C., 10 min | 80° C., 10 min | A+ | A+ | A+ | A+ |
| Example | 5 mol/L | 18 mol/L | 1.90 | 0.75 | 1510 | 87 |
| 1 | 90° C., 10 min | 90° C., 10 min | A+ | A+ | A+ | A+ |
| Example | 5 mol/L | 18 mol/L | 1.89 | 0.72 | 1500 | 89 |
| 16 | 120° C., 10 min | 120° C., 10 min | A+ | A+ | A+ | A+ |
| Example | 5 mol/L | 18 mol/L | 1.98 | 0.79 | 1520 | 87 |
| 17 | 150° C., 10 min | 150° C., 10 min | A+ | A+ | A+ | A+ |

| | | | | | |
|---|---|---|---|---|---|
| Comp. Ex. | (LiOH + NaOH) aq. | 1.10 | 1.10 | 1200 | 54 |
| 2 | 90° C., 20 min | C | C | C | C |
| Comp. Ex. | (LiOH + NaOH) aq. | 2.10 | 1.40 | 1000 | 60 |
| 5 | 120° C., 20 min | C | C | C | C |

In Tables 1 to 3, in the evaluation of magnetic material content, 1.75% by weight or more was rated A⁺ (very good); 1.55% by weight or more and less than 1.75% by weight was rated A (good); 1.30% by weight or more and less than 1.55% by weight was rated B (practically acceptable); and less than 1.30% by weight was rated C (poor). In the evaluation of oxygen concentration, 0.95% by weight or less was rated A⁺ (very good); more than 0.95% by weight and 1.00% by weight or less was rated A (good); more than 1.00% by weight and 1.10% by weight or less was rated B (practically acceptable); and more than 1.10% by weight was rated C (poor).

Also, for initial discharge capacity, 1450 mAh or more was rated A⁺ (very good); 1300 mAh or more and less than 1450 mAh was rated A (good); 1250 mAh or more and less than 1300 mAh was rated B (practically acceptable); and less than 1250 mAh was rate C (poor). For low-temperature discharge performance, 80% or more was rated A⁺ (very good); 75% or more and less than 80% was rated A (good); 70% or more and less than 75% was rated B (practically acceptable); and less than 70% was rated C (poor).

As shown in Tables 1 and 2, in Comparative Examples 1 and 4, the content of magnetic material in the hydrogen-absorbing alloy powder was less than that of Example 1.

Conversely, in Comparative Examples 1 and 4, the oxygen concentration in the hydrogen-absorbing alloy powder was higher than that of Example 1. It should be noted that the oxygen concentration in the hydrogen-absorbing alloy powder is proportional to the amount of oxides and hydroxides deposited on the surface of the hydrogen-absorbing alloy powder.

Also, as shown in Tables 1 and 2, Comparative Examples 1 and 4 exhibited lower initial discharge capacities than Example 1. This result was proportional to the content of magnetic material in the hydrogen-absorbing alloy powder. Further, Comparative Examples 1 and 4 exhibited lower low-temperature discharge performance than Example 1. This result was inversely proportional to the oxygen concentration of the hydrogen-absorbing alloy powder.

As described above, the treatment with the LiOH aqueous solution (first step) has a high treatment speed in an early stage, and this treatment can suppress the segregation of Mg. On the other hand, the treatment with the NaOH aqueous solution (second step) can suppress the saturation of the treatment amount, compared with the treatment with the LiOH aqueous solution.

Therefore, the combined use of the treatment with the LiOH aqueous solution and the treatment with the NaOH aqueous solution allowed a reduction in the oxygen concentration (an increase in magnetic material content) in a short treatment time, as shown in Examples 1 to 12, thereby permitting an efficient production of alkaline storage batteries with excellent low-temperature discharge performance.

Also, as is clear from the results shown in Table 1, when the LiOH concentration of the LiOH aqueous solution in the first step was set to preferably 0.1 mol/L or more, and more preferably 1 mol/L or more, the magnetic material content in the hydrogen-absorbing alloy powder could be heightened, and the oxygen content could be lowered.

However, when the LiOH concentration of the LiOH aqueous solution in the first step was made higher than 8 mol/L, no significant difference was observed in terms of improving the evaluation of the magnetic material content or oxygen concentration. It should be noted that the use of a very high concentration LiOH may damage the stirring device or increase costs. Also, when the LiOH concentration was 8 mol/L, slight crystallization of LiOH was found on the inner wall of the stirring vessel after the first step (Example 6). When the LiOH concentration was 10 mol/L, the degree of crystallization was significant (Example 7).

Also, as is clear from the results shown in Table 2, when the NaOH concentration of the NaOH aqueous solution in the second step was set to preferably 5 mol/L or more, and more preferably 8 mol/L or more, the magnetic material content in the hydrogen-absorbing alloy powder could be heightened, and the oxygen content could be lowered.

However, when the NaOH concentration of the NaOH aqueous solution in the second step was made higher than 20 mol/L, no significant difference was observed in terms of improving the evaluation of the magnetic material content or oxygen concentration. It should be noted that the use of a very high concentration NaOH may damage the stirring device or increase costs. Also, when the NaOH concentration was 20 mol/L, slight crystallization of NaOH was found on the inner wall of the stirring vessel after the second step (Example 11). When the NaOH concentration was 25 mol/L, the degree of crystallization was significant (Example 12).

Also, as is clear from the results shown in Table 3 (Examples 13 to 17 and Comparative Examples 2 and 5), when the treatment temperature of each of the first step and the second step was set to preferably 50 to 150° C., and more preferably 80 to 120° C., the magnetic material content in the hydrogen-absorbing alloy powder could be heightened, and the oxygen content could be lowered.

On the other hand, when the treatment temperature of each of the first step and second step was lower than the above range, the tendency of increased oxygen concentration and degraded low-temperature discharge performance was observed since the surface treatment reaction is unlikely to occur. Also, when the treatment temperature was 150° C., the surface treatment was sufficient, but there was a possibility that the stirring device might be damaged by bumping (Example 17).

### <Surface Treatment of Hydrogen-Absorbing Alloy Powder And Production of Nickel Metal Hydride Storage Battery>

### Example 18

A hydrogen-absorbing alloy powder represented by the compositional formula Mm_{0.7}Mg_{0.3} Ni_{2.75}Co_{0.5}Al_{0.05} (mean particle size 30 μm, CeNi₃ type, Ni content 53% by weight, Mg content 2% by weight) was prepared as a raw material in the same manner as in Example 1.

### (i) First Step

In the same manner as in Example 1, 10 kg of the raw material hydrogen-absorbing alloy powder was introduced into a stirring vessel, and then, 3 kg of a LiOH aqueous solution with a concentration of 5 mol/L was introduced therein. The first mixture was stirred for 10 minutes by rotating the stirring blades of the stirring vessel (first step). In the first step, the temperature of the first mixture was adjusted to a constant temperature of 90° C. After the completion of the first step, the first mixture was allowed to stand to settle the hydrogen-absorbing alloy powder, and the supernatant LiOH aqueous solution was removed from the stirring vessel.

### (ii) Second Step

After the removal of the supernatant fluid, 6 kg of a 10 mol/L KOH aqueous solution was introduced into the stirring vessel. The mixture of the hydrogen-absorbing alloy powder, the KOH aqueous solution, and the LiOH aqueous solution remaining in the stirring vessel (this mixture is referred to as a “second mixture” in this Example and Examples 19 to 34 described below) was stirred for 10 minutes by stirring the stirring blades (second step). In the second step, the temperature inside the stirring vessel was suitably controlled by a heating means, so that the temperature of the second mixture was adjusted to a constant temperature of 90° C. The content of LiOH in the second mixture was 0.03 pg/g or less per unit weight of the second mixture.

After the completion of the second step, the second mixture was introduced into a pressure filter, and filtrated under a pressure of 5 kgf/cm² to remove the KOH aqueous solution. The residue was then washed with a large amount of water to obtain the surface-treated hydrogen-absorbing alloy powder.

(iii) Preparation of Negative Electrode

A negative electrode mixture paste was prepared in the same manner as in Example 1, except for the use of 10 kg of the hydrogen-absorbing alloy powder subjected to the surface treatment by the first step using the LiOH aqueous solution and the second step using the KOH aqueous solution. A negative electrode (hydrogen-absorbing alloy negative electrode) was prepared in the same manner as in Example 1, except for the use of the negative electrode mixture paste thus obtained. The negative electrode had a theoretical capacity of 2200 mAh.

### (iv) Production of Nickel Metal Hydride Storage Battery

The negative electrode 12 was the above-described hydrogen-absorbing alloy negative electrode (see FIG. 1; hereinafter the same). The other components such as the positive electrode 11, the separator 13, and the alkaline electrolyte were the same as those used in Example 1. A nickel metal hydride storage battery illustrated in FIG. 1 was produced in the same manner as in Example 1, except that the negative electrode 12 was different.

### Examples 19 to 24

Nickel metal hydride storage batteries were produced in the same manner as in Example 18, except that the LiOH concentration of the LiOH aqueous solution in the first step was set to 0.05 mol/L in Example 19, 0.1 mol/L in Example 20, 1 mol/L in Example 21, 6 mol/L in Example 22, 8 mol/L in Example 23, and 10 mol/L in Example 24.

### Examples 25 to 29

Nickel metal hydride storage batteries were produced in the same manner as in Example 18, except that the KOH concentration of the KOH aqueous solution in the second step was set to 4 mol/L in Example 25, 5 mol/L in Example 26, 8 mol/L in Example 27, 13 mol/L in Example 28, and 15 mol/L in Example 29.

### Examples 30 to 34

Nickel metal hydride storage batteries were produced in the same manner as in Example 18, except that the temperature of the first mixture in the first step and the temperature of the second mixture in the second step were set to 40° C. (Example 30), 50° C. (Example 31), 80° C. (Example 32), 120° C. (Example 33), or 150° C. (Example 34).

### Comparative Example 6

10 kg of a raw material hydrogen-absorbing alloy powder, which was the same as that of Example 1, was introduced into a stirring vessel, and then, 6 kg of a KOH aqueous solution with a concentration of 10 mol/L was introduced therein. The mixture of the hydrogen-absorbing alloy powder and the KOH aqueous solution was stirred for 20 minutes by rotating the stirring blades of the stirring vessel. During the stirring, the temperature inside the stirring vessel was suitably controlled by a heating means, so that the temperature of the mixture was adjusted to a constant temperature of 90° C.

After the stirring, the mixture in the stirring vessel was allowed to stand to settle the hydrogen-absorbing alloy powder, and the supernatant KOH aqueous solution was removed from the stirring vessel. Subsequently, the hydrogen-absorbing alloy powder was washed with a large amount of water, to obtain the surface-treated hydrogen-absorbing alloy powder. That is, in Comparative Example 6, the first step of Example 18 (the treatment with the LiOH aqueous solution) was not performed, and only the second step (the treatment with the KOH aqueous solution) was performed and the treatment time was set to 20 minutes.

A nickel metal hydride storage battery was produced in the same manner as in Example 18 except for the use of the surface-treated hydrogen-absorbing alloy powder thus obtained.

### Comparative Example 7

10 kg of a raw material hydrogen-absorbing alloy powder, which was the same as that of Example 1, was introduced into a stirring vessel. Subsequently, an aqueous solution comprising a mixture of 1.5 kg of a LiOH aqueous solution with a concentration of 5 mol/L and 3 kg of a KOH aqueous solution with a concentration of 10 mol/L was introduced into the stirring vessel. The mixture of the hydrogen-absorbing alloy powder and the mixed aqueous solution was stirred for 20 minutes by rotating the stirring blades of the stirring vessel. During the stirring, the temperature inside the stirring vessel was suitably controlled by a heating means, so that the temperature of the mixture was adjusted to a constant temperature of 90° C.

After the stirring, the mixture in the stirring vessel was allowed to stand to settle the hydrogen-absorbing alloy powder, and the supernatant mixed aqueous solution of LiOH and KOH was removed from the stirring vessel. Subsequently, the deposit was washed with a large amount of water, to obtain the surface-treated hydrogen-absorbing alloy powder.

A nickel metal hydride storage battery was produced in the same manner as in Example 18 except for the use of the surface-treated hydrogen-absorbing alloy powder thus obtained.

### Comparative Example 8

A surface-treated hydrogen-absorbing alloy powder was prepared in the same manner as in Comparative Example 7, except that during the stirring, the temperature of the mixture in the stirring vessel was adjusted to a constant temperature of 120° C. A nickel metal hydride storage battery was produced in the same manner as in Example 18, except for the use of the surface-treated hydrogen-absorbing alloy powder thus obtained.

### <Evaluation of Physical Properties>

With respect to Examples 18 to 34 and Comparative Examples 6 to 8, the above-described measurements were made to evaluate the physical properties of their surface-treated hydrogen-absorbing alloy powders and the nickel metal hydride storage batteries using these alloy powders. The properties measured and evaluated were the same four as described above, i.e., magnetic material content, oxygen concentration, initial discharge capacity, and low-temperature discharge performance. The above results are shown in the following Tables 4 to 6.

TABLE 4

| | | | Magnetic | | Initial | Low-temperature |
|---|---|---|---|---|---|---|
| | <First step> | <Second step> | material | Oxygen | discharge | discharge |
| | LiOH conc. | KOH conc. | content | conc. | capacity | performance |
| | Treatment cond. | Treatment cond. | [wt %] | [wt %] | [mAh] | [%] |
| Comp. Ex. | — | 10 mol/L | 1.15 | 1.21 | 1200 | 68 |
| 6 | | 90° C., 20 min | C | C | C | C |
| Example | 0.05 mol/L | 10 mol/L | 1.31 | 1.10 | 1260 | 74 |
| 19 | 90° C., 10 min | 90° C., 10 min | B | B | B | B |
| Example | 0.1 mol/L | 10 mol/L | 1.52 | 0.92 | 1320 | 82 |
| 20 | 90° C., 10 min | 90° C., 10 min | A | A | A | A+ |
| Example | 1 mol/L | 10 mol/L | 1.79 | 0.83 | 1450 | 87 |
| 21 | 90° C., 10 min | 90° C., 10 min | A+ | A+ | A+ | A+ |
| Example | 5 mol/L | 10 mol/L | 1.87 | 0.74 | 1510 | 85 |
| 18 | 90° C., 10 min | 90° C., 10 min | A+ | A+ | A+ | A+ |
| Example | 6 mol/L | 10 mol/L | 2.20 | 0.79 | 1518 | 89 |
| 22 | 90° C., 10 min | 90° C., 10 min | A+ | A+ | A+ | A+ |
| Example | 8 mol/L | 10 mol/L | 2.35 | 0.62 | 1515 | 92 |
| 23 | 90° C., 10 min | 90° C., 10 min | A+ | A+ | A+ | A+ |
| Example | 10 mol/L | 10 mol/L | 2.34 | 0.70 | 1400 | 80 |
| 24 | 90° C., 10 min | 90° C., 10 min | A+ | A+ | A+ | A+ |

| | | | | | |
|---|---|---|---|---|---|
| Comp. Ex. | (LiOH + KOH) aq. | 1.20 | 1.30 | 1100 | 43 |
| 7 | 90° C., 20 min | C | C | C | C |
| Comp. Ex. | (LiOH + NaOH + KOH) aq. | 1.15 | 1.30 | 1230 | 59 |
| 3 | 90° C., 20 min | C | C | C | C |

TABLE 5

| | | | Magnetic | | Initial | Low-temperature |
|---|---|---|---|---|---|---|
| | <First step> | <Second step> | material | Oxygen | discharge | discharge |
| | LiOH conc. | KOH conc. | content | conc. | capacity | performance |
| | Treatment cond. | Treatment cond. | [wt %] | [wt %] | [mAh] | [%] |
| Comp. Ex. | 5 mol/L | — | 1.45 | 1.35 | 1280 | 50 |
| 4 | 90° C., 20 min | | B | C | B | C |
| Example | 5 mol/L | 4 mol/L | 1.58 | 1.21 | 1280 | 53 |
| 25 | 90° C., 10 min | 90° C., 10 min | B | B | B | B |
| Example | 5 mol/L | 5 mol/L | 1.60 | 0.97 | 1370 | 77 |
| 26 | 90° C., 10 min | 90° C., 10 min | A | A | A | A |
| Example | 5 mol/L | 8 mol/L | 1.82 | 0.90 | 1480 | 82 |
| 27 | 90° C., 10 min | 90° C., 10 min | A+ | A+ | A+ | A+ |
| Example | 5 mol/L | 10 mol/L | 1.87 | 0.74 | 1510 | 85 |
| 18 | 90° C., 10 min | 90° C., 10 min | A+ | A+ | A+ | A+ |
| Example | 5 mol/L | 13 mol/L | 1.99 | 0.63 | 1510 | 93 |
| 28 | 90° C., 10 min | 90° C., 10 min | A+ | A+ | A+ | A+ |
| Example | 5 mol/L | 15 mol/L | 2.20 | 0.70 | 1350 | 74 |
| 29 | 90° C., 10 min | 90° C., 10 min | A+ | A+ | A+ | A+ |

| | | | | | |
|---|---|---|---|---|---|
| Comp. Ex. | (LiOH + KOH) aq. | 1.20 | 1.30 | 1100 | 43 |
| 7 | 90° C., 20 min | C | C | C | C |
| Comp. Ex. | (LiOH + NaOH + KOH) aq. | 1.18 | 1.30 | 1230 | 59 |
| 3 | 90° C., 20 min | C | C | C | C |

TABLE 6

| | | | Magnetic | | Initial | Low-temperature |
|---|---|---|---|---|---|---|
| | <First step> | <Second step> | material | Oxygen | discharge | discharge |
| | LiOH conc. | KOH conc. | content | conc. | capacity | performance |
| | Treatment cond. | Treatment cond. | [wt %] | [wt %] | [mAh] | [%] |
| Example | 5 mol/L | 10 mol/L | 1.55 | 1.01 | 1150 | 70 |
| 30 | 40° C., 10 min | 40° C., 10 min | B | B | B | B |
| Example | 5 mol/L | 10 mol/L | 1.58 | 0.98 | 1350 | 79 |
| 31 | 50° C., 10 min | 50° C., 10 min | A | A | A | A |
| Example | 5 mol/L | 10 mol/L | 1.75 | 0.88 | 1440 | 85 |
| 32 | 80° C., 10 min | 80° C., 10 min | A+ | A+ | A+ | A+ |
| Example | 5 mol/L | 10 mol/L | 1.87 | 0.74 | 1510 | 85 |
| 18 | 90° C., 10 min | 90° C., 10 min | A+ | A+ | A+ | A+ |
| Example | 5 mol/L | 10 mol/L | 1.90 | 0.83 | 1500 | 88 |
| 33 | 120° C., 10 min | 120° C., 10 min | A+ | A+ | A+ | A+ |
| Example | 5 mol/L | 10 mol/L | 1.97 | 0.78 | 1520 | 89 |
| 34 | 150° C., 10 min | 150° C., 10 min | A+ | A+ | A+ | A+ |

| | | | | | |
|---|---|---|---|---|---|
| Comp. Ex. | (LiOH + KOH) aq. | 1.20 | 1.30 | 1100 | 43 |
| 7 | 90° C., 20 min | C | C | C | C |
| Comp. Ex. | (LiOH + KOH) aq. | 2.20 | 1.50 | 1100 | 65 |
| 8 | 120° C., 20 min | C | C | C | C |

In Tables 4 to 6, the evaluation ratings (A⁺ to C) for magnetic material content and oxygen concentration were the same as those in Tables 1 to 3. Also, the evaluation ratings (A⁺ to C) for initial discharge capacity and low-temperature discharge performance were the same as those in Tables 1 to 3.

As shown in Tables 4 and 5, in Comparative Examples 6 and 4, the content of magnetic material in the hydrogen-absorbing alloy powder was less than that of Example 18. Conversely, in Comparative Examples 6 and 4, the oxygen concentration in the hydrogen-absorbing alloy powder was higher than that of Example 18.

Also, as shown in Tables 4 and 5, Comparative Examples 6 and 4 exhibited lower initial discharge capacities than Example 18. This result was proportional to the content of magnetic material in the hydrogen-absorbing alloy powder. Further, Comparative Examples 6 and 4 exhibited lower low-temperature discharge performance than Example 18. This result was inversely proportional to the oxygen concentration of the hydrogen-absorbing alloy powder.

As described above, the treatment with the LiOH aqueous solution (first step) has a high treatment speed in an early stage, and this treatment can suppress the segregation of Mg. On the other hand, the treatment with the KOH aqueous solution (second step) can suppress the saturation of the treatment amount, compared with the treatment with the LiOH aqueous solution.

Therefore, the combined use of the treatment with the LiOH aqueous solution and the treatment with the KOH aqueous solution allowed a reduction in the oxygen concentration (an increase in magnetic material content) in a short treatment time, as shown in Examples 18 to 29, thereby permitting an efficient production of alkaline storage batteries with excellent low-temperature discharge performance.

Also, as is clear from the results shown in Table 4, when the LiOH concentration of the LiOH aqueous solution in the first step was set to preferably 0.1 mol/L or more, and more preferably 1 mol/L or more, the magnetic material content in the hydrogen-absorbing alloy powder could be heightened, and the oxygen content could be lowered.

However, when the LiOH concentration of the LiOH aqueous solution in the first step was made higher than 8 mol/L, no significant difference was observed in terms of improving the evaluation of the magnetic material content or oxygen concentration. Also, when the LiOH concentration was 8 mol/L, slight crystallization of LiOH was found on the inner wall of the stirring vessel after the first step (Example 23). When the LiOH concentration was 10 mol/L, the degree of crystallization was significant (Example 24).

Also, as is clear from the results shown in Table 5, when the KOH concentration of the KOH aqueous solution in the second step was set to preferably 7 mol/L or more, and more preferably 10 mol/L or more, the magnetic material content in the hydrogen-absorbing alloy powder could be heightened, and the oxygen content could be lowered.

However, when the KOH concentration of the NaOH aqueous solution in the second step was made higher than 13 mol/L, no significant difference was observed in terms of improving the evaluation of the magnetic material content or oxygen concentration. It should be noted that the use of a very high concentration KOH may damage the stirring device or increase costs. Also, when the KOH concentration was 13 mol/L, slight crystallization of KOH was found on the inner wall of the stirring vessel after the second step (Example 28). When the NaOH concentration was 15 mol/L, the degree of crystallization was significant (Example 29).

Also, as is clear from the results shown in Table 6 (Examples 30 to 34 and Comparative Examples 7 and 8), when the treatment temperature of each of the first step and the second step was set to preferably 50 to 150° C., and more preferably 80 to 120° C., the magnetic material content in the hydrogen-absorbing alloy powder could be heightened, and the oxygen content could be lowered.

On the other hand, when the treatment temperature of each of the first step and second step was lower than the above range, the tendency of increased oxygen concentration and degraded low-temperature discharge performance was observed since the surface treatment reaction is unlikely to occur. Also, when the treatment temperature was 150° C., the surface treatment was sufficient, but there was a possibility that the stirring device might be damaged by bumping (Example 34).

### INDUSTRIAL APPLICABILITY

According to the invention, alkaline storage batteries with excellent low-temperature discharge performance can be efficiently produced. Therefore, the invention is highly applicable as an electrode production technique for high power type alkaline storage batteries in such applications as power tools and electric vehicles, as well as being highly useful.

1. A method for treating a surface of a hydrogen-absorbing alloy powder, comprising:
a first step of stirring a first mixture that comprises a hydrogen-absorbing alloy powder containing Ni and Mg and having a Ni content of 35 to 60% by weight and a lithium hydroxide aqueous solution; and
a second step of stirring a second mixture that comprises the hydrogen-absorbing alloy powder subjected to the first step and an alkali metal hydroxide aqueous solution of at least one of sodium hydroxide and potassium hydroxide.

2. The method for treating a surface of a hydrogen-absorbing alloy powder in accordance with claim 1, wherein the lithium hydroxide aqueous solution has a lithium hydroxide concentration of 0.1 to 8 mol/L.

3. The method for treating a surface of a hydrogen-absorbing alloy powder in accordance with claim 1, wherein the alkali metal hydroxide aqueous solution contains sodium hydroxide and has a sodium hydroxide concentration of 7 to 20 mol/L.

4. The method for treating a surface of a hydrogen-absorbing alloy powder in accordance with claim 1, wherein the alkali metal hydroxide aqueous solution contains potassium hydroxide and has a potassium hydroxide concentration of 5 to 13 mol/L.

5. The method for treating a surface of a hydrogen-absorbing alloy powder in accordance with claim 1, wherein the first mixture has a temperature of 50 to 150° C.

6. The method for treating a surface of a hydrogen-absorbing alloy powder in accordance with claim 1, wherein the second mixture has a temperature of 50 to 150° C.

7. The method for treating a surface of a hydrogen-absorbing alloy powder in accordance with claim 1, wherein the hydrogen-absorbing alloy has a crystal structure of Ce₂Ni₇ type or CeNi₃ type.

8. A hydrogen-absorbing alloy powder subjected to the surface treatment method of claim 1.

9. The hydrogen-absorbing alloy powder in accordance with claim 8, having an oxygen concentration of 1.10% by weight or less.

10. The hydrogen-absorbing alloy powder in accordance with claim 8, having a magnetic material content of 1.30% by weight or more.

11. A negative electrode for an alkaline storage battery, including the hydrogen-absorbing alloy powder of claim 8.

12. An alkaline storage battery, comprising a positive electrode including nickel, the negative electrode for an alkaline storage battery of claim 11, and an alkaline electrolyte.
